(19) United States
(12) Patent Application Publication
(10) Pub. No.: US 2024/0189987 A1
(43) Pub. Date: Jun. 13, 2024

(54) Validation of a pose of a robot and of sensor data of a sensor moved along with the robot

(71) Applicant: SICK AG, Waldkirch (DE)

(72) Inventors: Jens GEBAUER, Waldkirch (DE); Christoph HOFMANN, Waldkirch (DE)

(21) Appl. No.: 18/535,120

(22) Filed: Dec. 11, 2023

(30) Foreign Application Priority Data
Dec. 12, 2022 (EP) 22212791.2

(51) Int. Cl. B25J 9/16; B25J 19/02

(52) U.S. Cl. CPC B25J 9/1605; B25J 9/1697; B25J 19/023

(57) ABSTRACT

A method of validating a pose of a robot and/or of sensor data of a sensor moved along with the robot is provided, wherein a robot controller determines the real pose of the robot and the sensor measures real sensor data, In this respect, a robot simulation determines a simulated pose of the robot by a simulated movement of the robot and a sensor simulation determines simulated sensor data of the sensor by a simulated sensor measurement and the validation takes place by at least one comparison of the real pose and the simulated pose of the robot, of real sensor data and simulated sensor data, and/or of simulated sensor data among one another.

The invention relates to a validation of a pose of a robot and/or of sensor data of a sensor moved along with the robot.

The primary goal of safety engineering is to protect persons from hazard sources. The hazard source looked at here is a robot, in particular in an industrial environment. The robot is monitored with the aid of sensors and accordingly, if a situation is present in which a person threatens to move into a hazardous situation with respect to the robot, a suitable safeguarding measure is taken. Sensors used in safety engineering have to work particularly reliably and must therefore satisfy high safety demands, for example the EN ISO 13849 standard for safety of machinery and the machinery standard IEC61496 or EN61496 for electrosensitive protective equipment (ESPE). To satisfy these safety standards, complex measures are conventionally taken such as a safe electronic evaluation by redundant, diverse electronics, functional monitoring, or monitoring of the contamination of optical components.

There is an increasing desire for closer cooperation with in the safety-engineering monitoring of robots, especially lightweight construction robots persons (HRC, human-robot collaboration), also in complex environments. Relevant standards in this connection are, for example, EN ISO 10218 for industrial robots or ISO/TS15066 for collaborative robots. Similar problems result for robots in a somewhat wider understanding of the term, for example AGVs/AGCs (automated guided vehicles/containers), drones

A basic requirement for a reliable safeguarding is that the assumptions of the safety monitoring on the pose of the robot sufficiently match reality. Pose here means the position and/or orientation of the robot in up to six degrees of freedom. There are even more degrees of freedom with a multi-membered robot; in this case the pose is frequently related to an end effector. The further requirement of a functional sensor has already been mentioned. There is, however, the desire here to satisfy the demands of the relevant safety standards in a simpler manner than through the laborious measures that already make a sensor per se into a safe sensor. In addition, all the functions simply cannot be checked from the sensor alone. For example, a safety sensor attached to a robot has to be traveled to a test position for this purpose to find known and properly defined environmental conditions for the test. Only a laborious test of demand that takes place sporadically is thus possible.

The validation of the pose or of the sensor data relates to tests, comparisons, or inspections by which the corresponding standardized reliability is ensured. There are different safety levels here that have different names depending on the standard. Two examples are the performance level (PL) a-e of EN 13849 and the safety integrity levels (SILs) 1-4 of EN 61508. Safe or validated in the context of this description means that standard requirements of one of said safety standards or of a comparable safety standard, in particular of a future subsequent standard, are observed at a specific safety level.

The concepts of validation have been unsatisfactory to date, which is not least due to the fact that there are no safe interfaces from the robot. For example, some industrial robots have a so-called coordinate boundary for which is it ensured that a robot will not depart from the coordinate boundary with a fixed likelihood. Examples for this are the functions of Dual Check Safety of Fanuc or SafeMove 2 of ABB. However, the actual pose of the robot within the virtual coordinate boundary is here not accessible from the outside in a safe or validated manner due to a lack of a safe interface. Universal robots provide a single safe spatial point as a safety function. However, this is not sufficient for general applications.

It is furthermore known in the prior art to simulate robot trajectories in advance and to then deploy it on the robot. A check is also made here whether the simulation has reached the robot. However, this is not a validation in the sense used here since this check is not safety related.

DE 10 2015 112 656 A1 discloses a distance sensor that is moved along at the end effector of a robot arm and whose measurement beams span a kind of virtual protective cover or protective jacket around the tool of the robot. On penetration of a safety related object, the robot is braked or stopped. The distance sensor is at least safely designed in combination with the superior controller, with, however, tests in the form of an already mentioned reference movement to a known reference point being required to achieve a higher safety level.

EP 3 988 256 A1 provides a more flexible protective cover by adaptation of the distance thresholds that equally specify the length of the measurement beams. A respective available maximum distance up to the next background object enters into this adaptation. The maximum distance is calculated using a topography of the environment. This extension does not change much with respect to a validation except that additional reference points could be derived from the known topography, which, however, EP 3 988 256 A1 does not discuss.

EP 4 008 497 A1 deals with the validation of the pose of a robot that is safeguarded by a co-moved distance sensor. However, a plurality of inertial sensors are additionally required for this that are co-moved at a respective member of the robot.

A system for the technical safety planning, configuration, and analysis of an industrial plant with a hazard potential is known from EP 2 378 445 B1 in which working conditions of the plant are simulated in three dimensions. Protected fields are configured using a sensor model and are shown graphically. This precedes the operation and therefore does not relate to any validation that is part of a safeguarding in real time. Nor does EP 3 654 125 B2 relate to the configuration of an industrial safety system. For this purpose, a digital twin is produced that simulates the system, including protected fields. How the digital twin can be kept in agreement with reality is only discussed peripherally and only with respect to the protected fields.

A method of monitoring a machine is provided in DE 10 2017 111 885 A1 in which the movement of the machine is determined while the machine is switched into a safe state. Stop times are in particular measured. For this purpose, a camera moved along with the robot records the environment from the ego perspective and its respective own positions are determined from the image sequence. A validation does not take place here.

EP 3 650 740 A1 determines the trajectory of a camera moved along with a machine part in a comparable manner and compares it with the movement that has been determined from position sensors at the machine. This is a possibility to check the trajectory of a robot. It is, however, very laborious. Defects of the camera are at best only indirectly noticed; the camera images per se are not validated.

It is therefore the object of the invention to provide an improved validation for the pose of a robot or the sensor data of a sensor moved along with it.

This object is satisfied by a method of validating a pose of a robot and/or of sensor data of a sensor moved along with the robot and by a system comprising a robot, a co-moved sensor, and a processing unit in which the method is implemented. A robot controller determine the real pose of the robot The term pose has already been defined in the introduction and describes the position and/or the orientation of the robot, preferably in the up to six degrees of freedom of an end effector. The real pose is the one with which the robot controller works for the control of the movements of the robot. Real pose is a counter-term on the simulated pose introduced later. The real poise is not yet necessarily the actually adopted pose. This correspondence has not yet been secured; that is the first aim of the validation of the pose. The robot controller can check the actually adopted post by measures beyond the measures presented here such as encoders at the joints of the robot.

A sensor is moved along with the robot, is preferably attached thereto so that the sensor adopts a pose corresponding in position and/or orientation with the robot except for a possible offset. The sensor measures real sensor data, either in the form of raw data or their processing into measured values. Again, the term real sensor data distinguishes from simulated sensor data still to be introduced. Validation of sensor data means that a check is made whether sensor data corresponding to the expected safe function of the sensor are measured. Which sensor data are measured depends, in addition to the sensor and its operability, on further conditions such as the pose and the detected environment.

The invention starts from the basic idea of simulating the robot and the sensor, of thereby generating a simulated pose and simulated sensor data, and of carrying out a validation of the pose and sensor data by various cross-comparisons. A robot simulation virtually carries out movements of the robot from which a respective simulated pose results. A sensor simulation simulates measurements of the sensor in particular from the real pose or the simulated pose form which respective simulated sensor data result. The robot simulation and the sensor simulation are also called digital twins of the robot or of the sensor because they virtually reproduce the relevant properties of the simulated object as faithfully as possible. Depending on the embodiment of the invention, different comparisons and combinations of comparisons are now possible for the validation. They include a comparison of the real pose and the simulated pose of the robot, a comparison of real sensor data and simulated sensor data, and/or a comparison of simulated sensor data among one another, with comparisons of sensor data preferably being based on different scenarios such as form a real pose of the robot and a simulated pose of the robot. The pose or the sensor data exactly then count as validated when the comparison produces a sufficient correspondence. Which tolerances are tolerated over which time period can be fixed, for example, by thresholds, percentage differences, and repeats of the validation or time windows, with the tolerances being able to be fixed in dependence on the safety level to be achieved.

It is a computer implemented method that runs, for example, on a separate safety controller or on another processing module that is connected to the at least one distance sensor and the robot. An implementation in the robot controller or a distributed implementation is also conceivable.

The invention has the advantage that a variety of validation possibilities of a high and adaptable quality are achieved by the interaction of simulated and real data. The sensor data can close the validation circle and correctly include the robot with its pose. The real or simulated sensor data or variables derived therefrom such as distance values or protected fields can be visualized in a supporting manner, in particular particularly intuitively by means of augmented reality. Validations in accordance with the invention can be retrofitted here. They manage with the available interfaces of conventional robots not designed for safety. The method here can be used with the most varied robots and robot types having a different number of axes and kinematically redundant robots, in particular in cobots and industrial robots.

The robot is preferably switched into a safe state when the pose of the robot is not validated and/or when the sensor data are not validated. Safety cannot be ensured due to a lack of a successful validation. A safe state means that an accident is precluded, which is achieved in dependence on the use and situation by measures such as slower movements, a restricted work zone, or if necessary a stopping of the robot. As already mentioned, the validation is preferably not a transient or minor deviation; such tolerances have already entered into the failed validation.

The sensor simulation preferably comprises an environmental simulation of an environment of the robot and the simulated sensor data are determined while including the environmental simulation. The simulated sensor data are thus produced from the interaction of the sensor simulation with the simulated environment. The real sensor data are correspondingly determined under the influence of the real environment; this takes place automatically as part of the measurement. The environment is, for example, a work area with the objects located therein. For optical sensors, it is the surface that is primarily of interest and in the case of a distance measurement only its topography, i.e. a 3D contour of the environment of the robot. A movement preferably does not take place in the relevant environment; an environmental simulation in the actual sense is then not required, a model of the static environment is sufficient that is measured in advance or is specified, for example, as a CAD model that has anyway frequently been prepared for robot cells. Moving simulations such as kinematically animated models, for instance from an industrial metaverse, are, however, also conceivable.

The robot preferably has an end effector and the real pose of the robot has a real pose of the end effector and the simulated pose of the robot has a simulated pose of the end effector, in particular determined by means of forward kinematics. The end effector, to which typically a tool having a pointed or sharp contour, a heated work head, or the like is fastened, is the main hazard source as a rule. It is therefore particularly advantageous to fix the pose to be validated at the end effector. The pose of the end effector can be determined from the individual joint positions by means of the forward kinematics and in particular by means of a Denavit-Hartenberg transformation. A robot controller anyway typically determines the forward kinematics for the control of the work routine. The robot simulation is likewise correspondingly formed in accordance with this embodiment, including the inclusion of an end effector or forward kinematics.

The sensor is preferably moved along with the end effector at the robot. A tool at the end effector and the longest lever or part of the robot with the largest range are thereby particularly effectively monitored to recognize hazards in good time and to respond appropriately to them. These properties of the sensor and properties of the sensor explained further below are preferably transferred to the sensor simulation.

The sensor is preferably a TOF camera or a contactlessly measuring distance sensor that measures a distance value along at least one sight beam, in particular an optoelectronic sensor that is configured for the measurement of distances using a time of flight process. Such distance sensors can be built inexpensively, as light, and as compact and are able to reliably recognize safety related intrusions. Distance values are preferably measured for a plurality of sight beams, with a plurality of sight beams emanating from the same distance sensor, a respective one sight beam emanating from one of a plurality of distance sensors, or one-beam and multi-beam distance sensors being used in a mixed form. A TOF camera (time of flight, 3D camera with measurement of the time of flight in its pixels) spans sight beams with every pixel, with pixels being able to be combined or selected to produce specific sight beams.

The distance sensor is preferably a safe sensor and/or the functionality of the distance sensor is cyclically checked and/or the distance values of a plurality of distance sensors are compared with each other to produce safe distance values. Some further measures to achieve a safe sensor are thus taken in addition to the validation in accordance with the invention via simulations. An even higher safety level can thus in particular be achieved. As already mentioned in the introduction, terms such as “safe” or “safety sensor” in the sense of this description are always to be understood such that a safety standard for applications in safety engineering or for accident avoidance in the industrial area is satisfied, in particular for machine safety, electrosensitive protective equipment, industrial robots, collaborations with robots, or the like. They can be the standards named in the introduction or their successors, expanded versions, or respective corresponding versions in other regions of the world.

The distance values measured along a respective sight beam are preferably compared with a distance threshold to decide whether the robot has been switched to a safe state. Protective sight beams of a length corresponding to the distance threshold are thereby spanned starting from the sensor. The sight beams thus form a visual protective cover by which a hazardous approach toward the robot is recognized. Intrusions into the sight beams outside the distance threshold have a sufficient distance from the robot and are no longer safety related. The distance thresholds can differ from one another so that the protective cover has a corresponding contour and can also be dynamically adapted, for example on an approach toward a work area.

The real pose provided by the robot controller is preferably compared with the simulated pose of the robot simulation. Initially only a correspondence of the presentations of the robot controller and the robot simulation are thus checked via the movements and the pose of the robot. This can, however, be a requirement for further steps of the validation. In other embodiments, the correspondence between the real pose and the simulated pose is checked in another manner or indirectly.

A reconstructed pose of the robot is preferably determined from the real sensor data and/or from the simulated sensor data and is compared with the real pose and/or with the simulated pose. With knowledge of the environment, the sensor data allow respective conclusions to be drawn on the pose in which they were detected. This is often not yet unique, but with a corresponding multiple detection from a plurality of poses, the movement and thus the pose adopted at a respective point in time can be reconstructed. The pose reconstructed from the sensor data can then be compared with the real pose from the robot controller or with the simulated pose as the validation or part of the validation. The starting point of this validation is the sensor data, but the comparison does not take place on the level of sensor data, but from a pose reconstructed therefrom.

Real sensor data are preferably detected by the sensor in a real pose reached after a movement of the robot and are compared with simulated sensor data that the sensor simulation determines in a simulated pose that was reached after simulation of the movement in the robot simulation. This validation will only be successful if the robot simulation successfully predicts or replicates the movements of the robot. The implementation of the robot simulation (deployment) is in particular thus checked in a safe manner.

Real sensor data are preferably detected by the sensor in a real pose reached after a movement of the robot and are compared with simulated sensor data that the sensor simulation determines in a simulated pose that was reached after simulation of the movement in the robot simulation. In this procedure, only real data, namely real sensor data from a real pose of the robot, are on the one side of the comparison and purely simulated data, namely simulated sensor data based on a simulated pose of the robot, on the other side. A correspondence indicates that the combined simulation of the robot and the sensor sufficiently meets reality. The function of the sensor and at the same time the pose of the robot are thus validated. For, with false assumptions of the pose, there would be no correspondence of the sensor data, at least not over a movement with a plurality of poses. The observation only applies with a successful validation since with no correspondence it is not clear whether the error is with the sensor data or the pose. This is, however, not important from a technical safety point of view since a relevant error has anyway been uncovered; where this error is exactly located is at most for a diagnosis and error analysis of interest, but not for the accident avoidance itself.

Real sensor data are preferably detected by the sensor in a real pose reached after a movement of the robot and are compared with simulated sensor data that determine the sensor simulation in the real pose. The procedure is similar to that of the preceding paragraph. Only real sensor data from a real pose of the robot are again on the one side of the comparison. However, a hybrid of simulation and reality is now on the other side of the comparison since the sensor simulation is placed over the real pose. Only the function of the sensor is thus validated, and indeed directly since the pose is now excluded as an error source.

It can thus also be clarified by a combination of the two last described validations whether a failure of a validation is to be ascribed to the sensor or to the pose. This is an example for it being able to be sensible to combine a plurality of validations with one another to achieve a higher safety level or an improved diagnosis. The invention also comprises the further combinations of the explained validations.

In an advantageous further development, a system is provided that has a robot, a robot controllers, a sensor moved along with the robot, and a processing unit at least indirectly connected to the robot controller and to the sensor. A robot simulation for simulating movements of the robot and a sensor simulation for simulating measurements of the sensor are deployed in the processing unit as well as an embodiment of a method in accordance with the invention for validating a pose of the robot and/or of sensor data of the sensor. The system thus comprises the robot, the co-moved sensor, its respective digital twin, and a processing unit to carry out the validation by comparisons between the real and the simulated poses or the real and the simulated sensor data.

The invention will be explained in more detail in the following also with respect to further features and advantages by way of example with reference to embodiments and to the enclosed drawing. The Figures of the drawing show in:

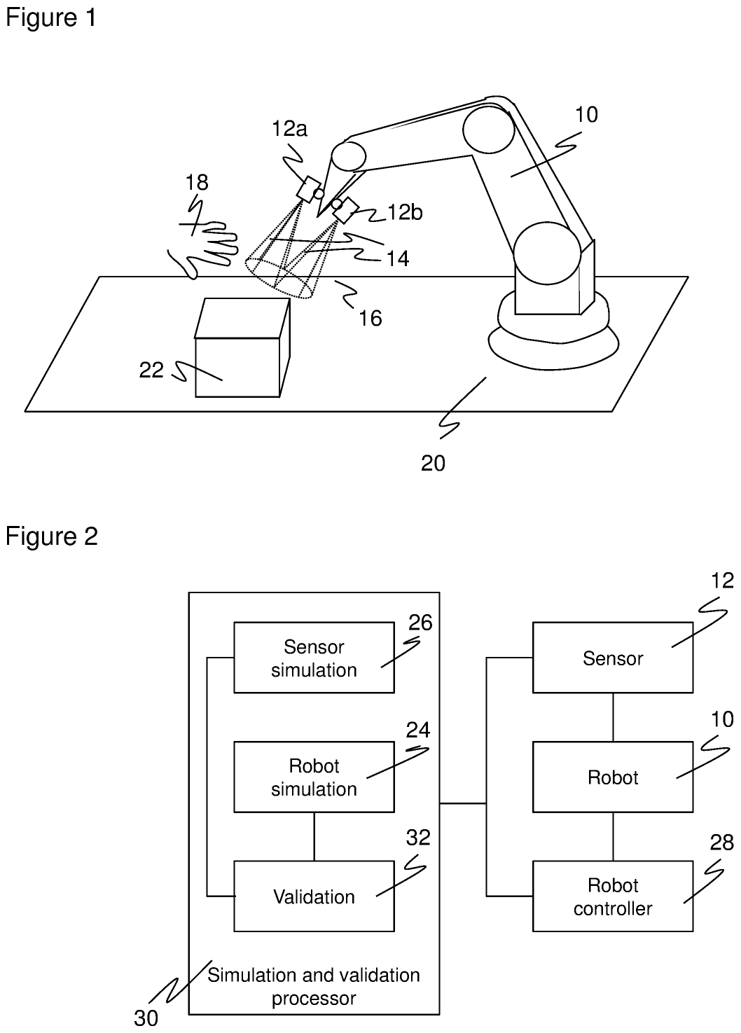

FIG. 1 an overview representation of a robot with a sensor attached to it and moved along with it;

FIG. 2 a block diagram of a system of a robot, a co-moved sensor, and associated digital twins, i.e. a robot simulation and a sensor simulation;

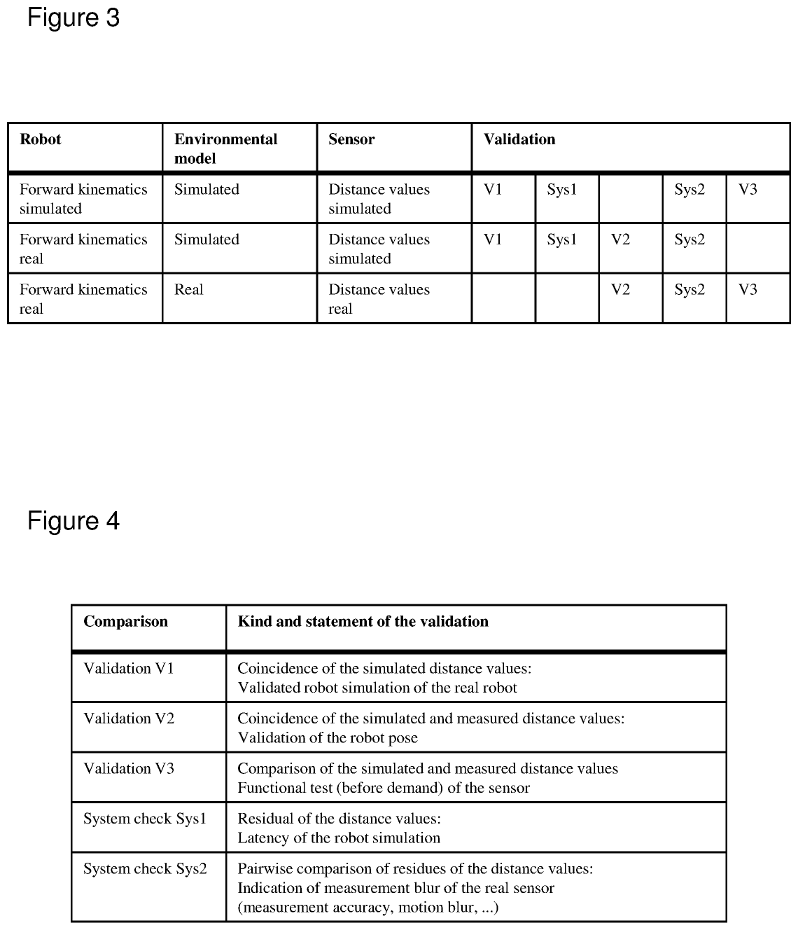

FIG. 3 a table that lists different validations based on real and simulated data;

FIG. 4 a table that lists properties and advantages of respective validations;

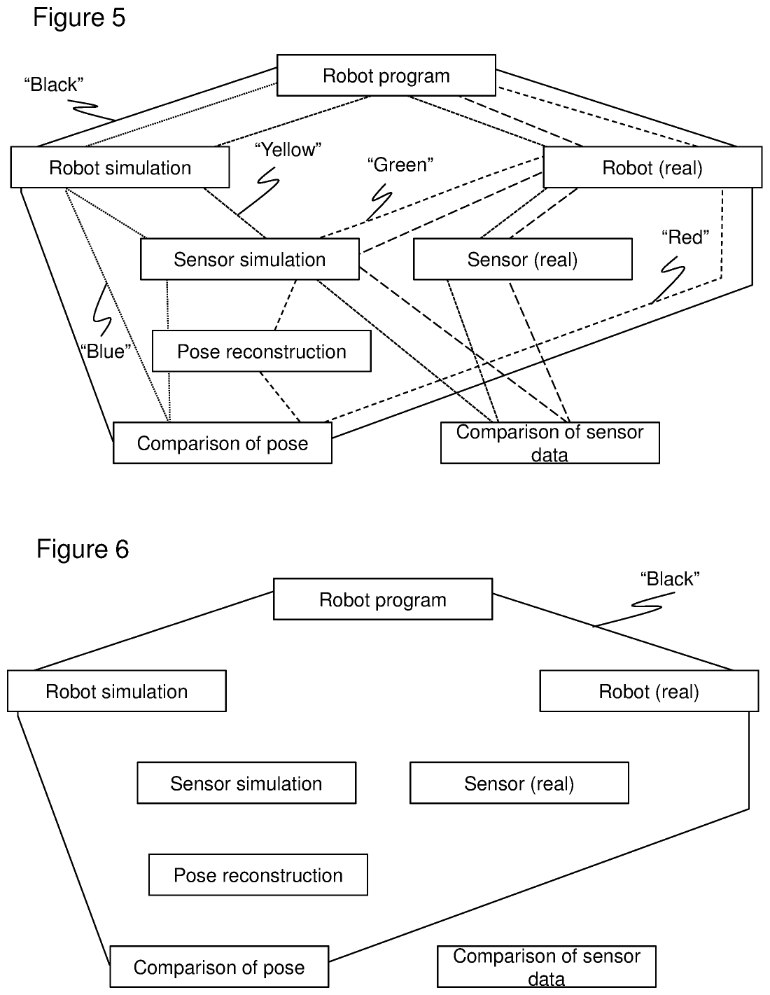

FIG. 5 an overview of different validation paths;

FIG. 6 a detail representation of FIG. 5 with only one validation path that compares real and simulated poses of the robot with one another;

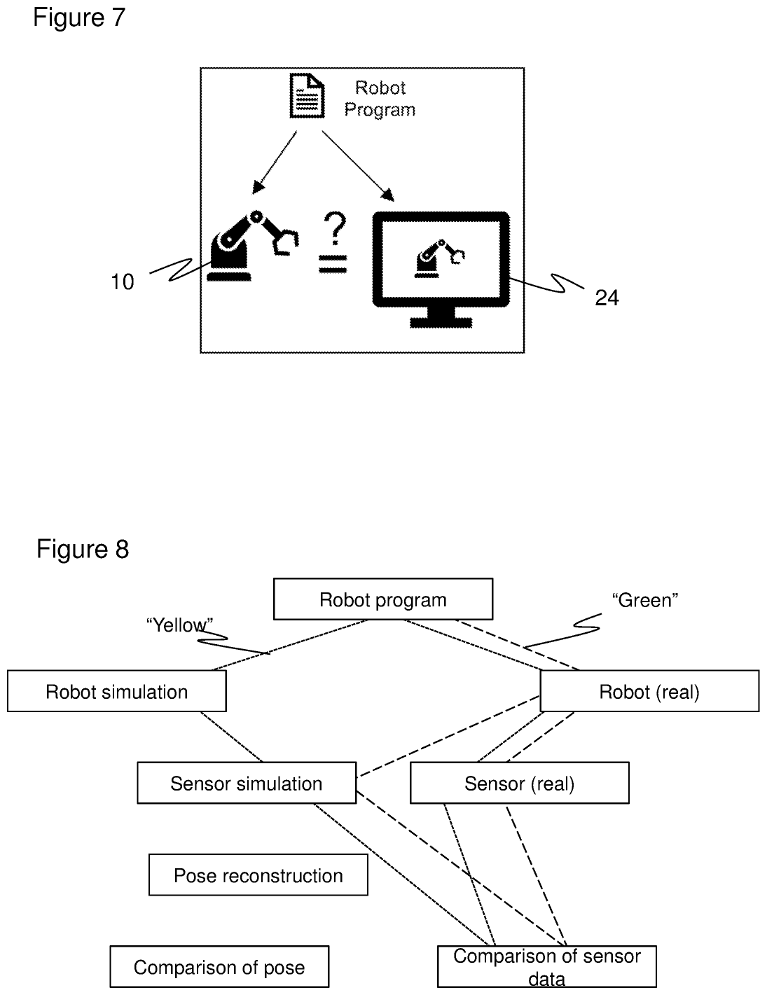

FIG. 7 an alternative representation of the validation path in accordance with FIG. 6;

FIG. 8 a detail representation of FIG. 5 with two of its evaluation paths that compare real and simulated sensor data with one another;

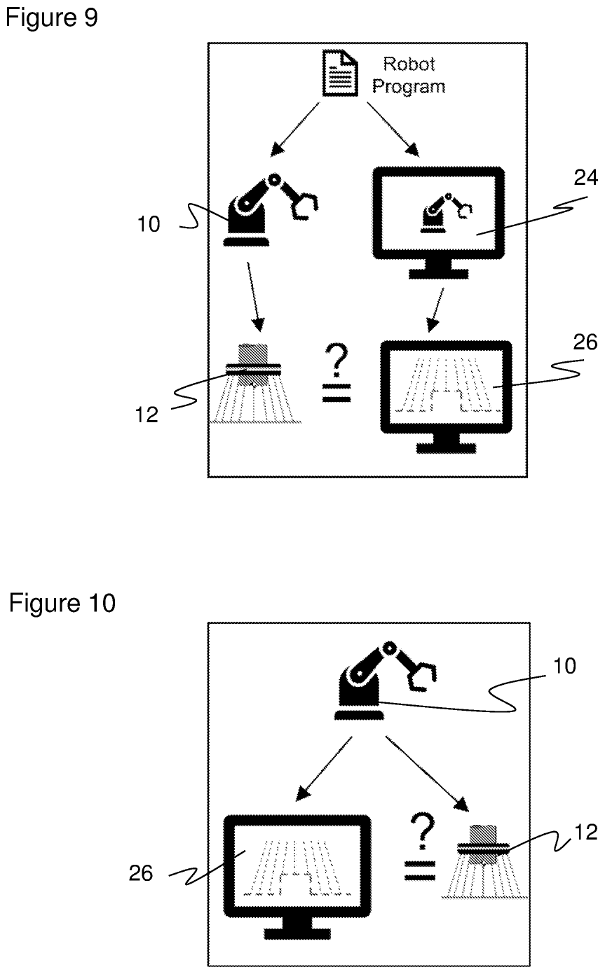

FIG. 9 an alternative representation of the validation path in accordance with FIG. 8;

FIG. 10 an alternative representation of the other validation path in accordance with FIG. 8; and

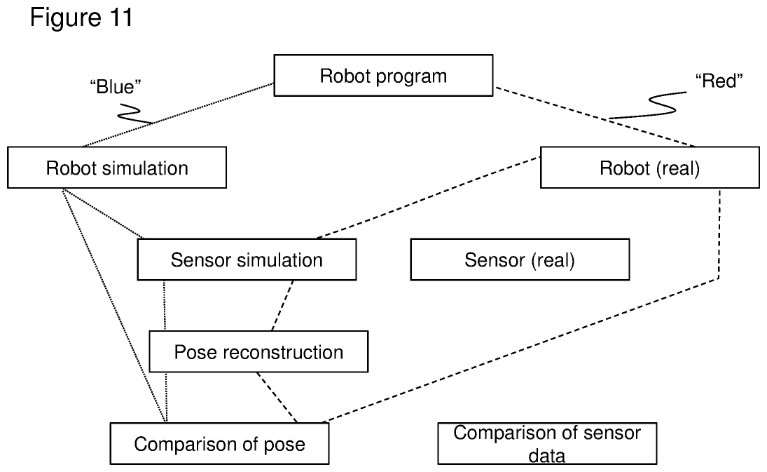

FIG. 11 a detail representation of FIG. 5 with two of its validation paths that reconstruct a pose from sensor data and compare the reconstructed pose with a real pose or with a simulated pose.

FIG. 1 shows an overview representation of a robot 10 that is to be safeguarded and that cooperates with an operator in a pick-and-place scenario. The embodiment of the robot 10 as a robot arm and the specific application are examples and the subsequent explanations can be transferred to any desired robots and scenarios, in particular AGVs/AGCs (automated guided vehicles/containers) or drones.

To specifically safeguard the end at its tip here, distance sensors 12a-b are attached to the robot, 10, preferably in the environment of a tool for its safeguarding (EOAS, end of arm safeguarding). The distance sensors 12a-b determine distance values along a plurality of sight beams 14. The shown number of two distance sensors 12a-b is purely by way of example; there can be more distance sensors or only one distance sensor that can then, however, measure along a plurality of sight beams 14. Generally, one or more sight beams 14 emanate from each distance sensor 12a-b. Sight beams 14 can be approximately geometrical beams or can have a finite cross-section if, for example, the distance sensor 12a-b works as an area sensor having a fanned out light beam. Optoelectronic distance sensors, for example with a measurement of the time of flight (TOF) are particularly suitable as distance sensors 12a-b. DE 10 2015 112 656 A1 named in the introduction presents such a system to which reference is additionally made. There are, however, also other optoelectronic sensors to determine distances such as laser scanners and 2D or 3D camera and other safeguarding concepts of a robot 10 having a sensor than by measuring distances, just like completely different technologies, for instance ultrasound sensors, capacitive sensors, radar sensors, and the like. The safeguarding by means of distance sensors 12a-b is therefore to be understood as an example just like the application scenario and the robot 10.

The distance values measured by the distance sensors 12a-b are compared with distance thresholds during operation. The distance thresholds define a section of the sight beams 14 that emanates from the respective distance sensor 12a-b and that can be called a protective beam. The protective beams together form a kind of virtual protective jacket or a virtual protective cover 16 around the end effector. The distance thresholds can be set differently depending on the sight beam 14 and/or the movement section of the robot 10. If, for example, a person intrudes into the zone safeguarded by means of the protective cover 16 with his hand and thus interrupts one of the sight beams 14 at a shorter distance than the associated distance threshold, the protective cover is considered infringed. A safety related response of the robot 10 is therefore triggered that can comprise a slowing down, an evasion, or an emergency stop in dependence on the infringed distance thresholds. Without a foreign object such as the hand 18, the distance sensors 12a-b measure the respective distance from the environment that is shown as representative in FIG. 1 by a working area 20 and an object 22.

FIG. 2 shows a block diagram of a system of the robot 10, the co-moved sensor 12, and associated digital twins, i.e. a robot simulation 24 and a sensor simulation 26. The robot 10 is controlled by a robot controller 28. The simulations 24, 26 are deployed on a processing unit 30 that provides digital processing and storage capacities on any desired hardware, for example as a safety controller, as a dedicated computer, as an edge device, or also as a cloud. The processing unit 30 furthermore comprises a validation unit 32 in which real and simulated data can preferably be compared in real time to carry out the validations still to be described with reference to different embodiments.

The robot simulation 24 can be mapped, for example, on an ROS (robot operating system) and a trajectory of the robot 10 or of the simulated robot can be planned using MovelT, for example. Alternatively, different deployments are conceivable, for example native simulation programs from robot manufacturers such as RobotStudio from ABB or URSim from Universal Robots.

The sensor simulation 26 can be based on EP 3 988 256 A1 named in the introduction for the example of distance sensors 12a-b. Sensor data naturally do not solely depend on the sensor 12, but also decisively on the environment. Strictly speaking, a digital twin of the environment must correspondingly be created for the sensor simulation 26. This is generally conceivable and covered by the invention. The simulation of a complex dynamic environment can, however, frequently not be handled. It may therefore be sensible to have a restriction to a surface model as a digital twin of the environment, that is to the topography or contour of, for example, the work surface 20 and of a known object 22 in the example of FIG. 1. As already mentioned, a more complex and in particular dynamic twin of the environment is not precluded. In the following, the understanding of the sensor simulation 26 is that the environment or its digital twin is taken into account therein. In accordance with EP 3 988 256 A1, sight beams 14 having the known topography are sectioned for this purpose to simulate distance measurements from the environment.

In summary, there are thus four data sources for a validation, of which two are real and two are virtual or simulated. The robot controller 28 delivers the respective real pose of the robot 10. It is in particular the forward kinematics that indicate the pose of an end effector (TCP, tool center point) of the robot 10 in up to six degrees of freedom of the position and of the rotation. The sensor 12 measures real sensor data that depend on the perspective of the sensor 12 and thus on the real pose of the robot 10. The robot simulation 24 correspondingly generates a respective simulated pose of the robot 10 and the sensor simulation 26 generates respective simulated sensor data, with them selectively being able to be simulated from the real pose or from the simulated pose.

The poses of the robot 10 and the sensor data are now validated using this system. The validation counts as failed if tolerable thresholds in the differences or time windows of a tolerated deviation are exceeded in the comparisons. The robot 10 is then preferably switched into a safe state.

FIG. 3 shows a table that lists different validations based on real and simulated data. Expectations are generated by the simulations here and are compared with one another or with real data. Different combinations of real and simulated data from the robot, environmental model, and sensor are given in the three right hand columns. Abbreviations for various validations and system checks are given in the right hand column that are made possible by the respective combination, with a system check likewise being able to be understood as a validation, at least in a further sense, because a function is thereby checked. If, for example, V1 appears in the first and second lines, the corresponding combinations from the three left hand columns are suitable to deliver the two comparison values for the validation V1. This applies accordingly to the other abbreviations.

FIG. 4 shows a table in which the validations from the right hand column of the table of FIG. 3 are explained in a brief manner. A validation V1 checks the correspondence of the simulated sensor data, in particular of the simulated distance values. The forward kinematics is read from the robot controller in somewhat more detail and a real pose is thus acquired. This is fed into the sensor simulation to simulate sensor data from the real pose. The same takes place with the forward kinematics that are simulated in the robot simulation 24 and by means of which the sensor simulation 26 simulates sensor data from the simulated pose. Surfaces can be selected as the virtual environment in the sensor simulation 26 that reproduce an application as faithfully as possible, or alternatively also any desired fictitious surfaces. The sensor data simulated in two different manners will only correspond if the robot simulation 24 actually predicts the movements of the robot 10 (correct deployment).

A validation V2 is placed over the real pose with two comparison values. Sensor data are really measured once and simulated once with this starting point and the two are compared with each other. The sensor simulation here has to use an environment that is as true to reality as possible; otherwise no correspondence can be expected. A successful validation V2 validates the pose of the robot 10, in particular of the end effector in all six degrees of freedom. In the case of distance sensors 12a-b, individual sight beams 14, all the sight beams 14, or a subset thereof can be used as the basis, with the subset being able to be permutated systematically or arbitrarily. The validation V2 can only be required for a certain minimum number of sight beams 14 or a statistical measure of deviations is checked over sight beams 14. The non-use of all the sight beams 14 for the validation has the advantage that sight beams 14 are still available in intrusion situations, for example by the hand, in which a correspondence can be expected between the simulation and reality. This would namely not apply to the unexpected hand 18 that cannot be considered in the environmental model so that sight beams 14 affected thereby do not allow any validation and thus safe determination of the pose of the robot 10 that is required, for example, for an evasion maneuver.

A validation V3 forms the third combination of the three lines from the table of FIG. 3 lacking up to now. Unlike the validation V2, the sensor simulation 26 now in accordance with the first line instead of the second line is based on a simulated pose. This makes a function test of the sensor 10 possible.

A system check Sys 1 is based on the same combination system of data as the validation V1 and evaluates the residual error of the distance values to draw a conclusion on the latency of the robot simulation therefrom. A system check Sys2 uses all three data sources of the lines from the table in accordance with FIG. 3 and carries out a pairwise comparison of the residual errors of the distance values. Indications of measured errors can thus be found or the measurement accuracy of the sensor 12 can be evaluated to which effects such as a motion blur can also contribute in addition to system immanent measured errors.

It is very particularly advantageous to form combinations of these validations, in particular the combination of the validations V1+V2+V3, to thus achieve a desired or higher safety level of the system. Other combinations are equally conceivable, also including the system check Sys1 and/or Sys2.

FIG. 5 shows an overview of possible validation paths. This is an alternative representation of possible validations that overlaps at least in parts with the tables of FIGS. 3 and 4. Most of the components involved in FIG. 5 have already been presented or are self-explanatory against the background of the previous explanations such as the comparisons shown below of poses and sensor data, with reference numerals having been dispensed with for reasons of clarity. In addition, there is a robot program as a root that should only form a common parenthesis and a pose reconstruction still to be described.

In accordance with the pure combination system, there would be a myriad of paths through the components of FIG. 5 corresponding to the numerous possibilities of using or not using the four data sources of real robot 10, robot simulation 24, real sensor 12, and sensor simulation 26 and of comparing them with one another. However, only some of these paths are really advantageous for a validation and FIG. 5 highlights five of such paths. Only linear patterns are provided to distinguish the paths in a black and white representation. They additionally have color legends to better distinguish the paths linguistically. There are accordingly a black, a blue, a red, a green, and a yellow path. These colors are only names to be able to separate the paths from one another linguistically. The validation of a path includes the associated communication paths.

To rectify the superposed representation of FIG. 5, FIG. 6 only shows the “black” validation path. The real pose from the robot controller 28 and the simulated pose from the robot simulation are thus compared with one another, in particular the real and the simulated pose of the end effector (TOP). FIG. 7 illustrates this in an alternative representation. Real or simulated sensor data do not enter into the “black” path. Forward kinematics are preferably calculated to determine the real and simulated poses and indeed again preferably for diversification over different hardware of the robot controller 28 and the robot simulation 24 or the processing unit 30. As in all comparisons for a validation, a greater robustness can be achieved by taking a tolerance into account. A systematic offset can also be tolerated that originates from a known latency between the robot 10 and the robot simulation 24. To avoid such latencies between the two calculations where possible, it may be sensible to establish a synchronization link. It would also be possible to draw a conclusion on the other variables from a relationship between the offset and latency from the one variable.

FIG. 8 shows a detailed representation of FIG. 5 with the “yellow” and “green” paths. Real and simulated sensor data on these validation paths are compared with one another. In this respect, the sensor simulation 26 of the “yellow” path is based on the simulated pose of the robot simulation 24 and that of the “green” path on the real pose of the robot controller 28.

FIG. 9 shows an alternative representation of the “yellow” path. In the left hand part, only real data are detected, namely real sensor data based on the real pose. A comparison is made in accordance with the right hand part of FIG. 9 with simulated sensor data based on a simulated pose. The “yellow” path contains the validation path V2 already discussed above. The real and simulated sensor data will only correspond if both the robot simulation 24 and the sensor simulation 26 present expectations that are satisfied by the robot 10 and the sensor 12.

FIG. 10 shows an alternative representation of the “green” path. The first part of the “yellow” path is here cut-off so-to-say since real sensor data like simulated sensor data are based on the real pose. Only the sensor function is therefore directly validated here. The “green” path corresponds to the validation path V2 already discussed above.

FIG. 11 shows a further detailed representation of FIG. 5 with the “blue” and “red” paths. A pose reconstruction (matching algorithm) is added as a further module here. With knowledge of the environment, a conclusion can be drawn from the simulated sensor data as to which real or simulated pose the robot has adopted in the sensor simulation 26. The reconstructed pose can then be compared with the real pose or the simulated pose. The sensor simulation 26 is thus validated. It would possibly be more precise only to speak of a plausibilization here. Ambiguities in the repeating environmental structures or in a structureless environment such as the empty work area 20 can have the result that the reconstructed pose is not located or shows a coincidence that is actually not present. The “blue” and “red” paths differ from one another in that the simulated pose of the robot simulation 24 enters into the sensor simulation 26 in the “blue” path and the reconstructed pose is accordingly compared with the simulated pose while the real pose enters in the “red” path and is compared therewith.

It has already been mentioned above that is may be sensible to combine paths with one another to thus achieve a higher error recognition likelihood of the overall system. Embodiments are also conceivable here with any desired combinations of the paths shown in FIG. 5. A simultaneous application of the “black” path that validates the pose and of the “green” path that validates the sensor data is particularly interesting. Both are also validated by the “yellow” path alone, however only with an only indirect validation of the pose and without any diagnostic possibility whether a failed validation was caused by deviations between the robot 10 and the robot simulation 24 or between the sensor 12 and the sensor simulation 26. It is naturally possible to combine the “black” path with the “yellow” path to achieve a more reliable validation and in particular to achieve this differentiation.

1. A computer implemented method of validating a pose of a robot and/or of sensor data of a sensor moved along with the robot, wherein a robot controller determines the real pose of the robot and the sensor measures real sensor data,
wherein a robot simulation determines a simulated pose of the robot by a simulated movement of the robot and a sensor simulation determines simulated sensor data of the sensor by a simulated sensor measurement; and wherein the validation takes place by at least one comparison of the real pose and the simulated pose of the robot, real sensor data and simulated sensor data, and/or of simulated sensor data among one another.

2. The method in accordance with claim 1,
wherein the robot is switched into a safe state when the pose of the robot is not validated and/or when the sensor data are not validated.

3. The method in accordance with claim 1,
wherein the sensor simulation comprises an environmental simulation of an environment of the robot and the simulated sensor data are determined while including the environmental simulation.

4. The method in accordance with claim 1,
wherein the robot has an end effector and the real pose of the robot has a real pose of the end effector and the simulated pose of the robot has a simulated pose of the end effector.

5. The method in accordance with claim 1,
wherein the robot has an end effector and the real pose of the robot has a real pose of the end effector and the simulated pose of the robot has a simulated pose of the end effector determined by means of forward kinematics.

6. The method in accordance with claim 4,
wherein the sensor moved along with the end effector is attached to the robot.

7. The method in accordance with claim 5,
wherein the sensor moved along with the end effector is attached to the robot.

8. The method in accordance with claim 1,
wherein the sensor is a TOF camera or a contactlessly measuring distance sensor that measures a distance value along at least one sight beam.

9. The method in accordance with claim 8,
wherein the sensor is an optoelectronic sensor that is configured for the measurement of distances using a time of flight process.

10. The method in accordance with claim 8,
wherein the distance values measured along a respective sight beam are compared with a distance threshold to decide whether the robot has been switched into a safe state.

11. The method in accordance with claim 1,
wherein the real pose provided by the robot controller is compared with the simulated pose of the robot simulation.

12. The method in accordance with claim 1,
wherein a reconstructed pose of the robot is determined from the real sensor data and/or from the simulated sensor data and is compared with the real pose and/or the simulated pose.

13. The method in accordance with claim 1,
wherein first simulated data in a real pose are determined by means of the sensor simulation after a movement of the robot and second simulated sensor data are determined in a simulated pose after the movement simulated by means of the robot simulation and the first simulated sensor data and the second simulated sensor data are compared with one another.

14. The method in accordance with claim 1,
wherein real sensor data are detected by the sensor in a real pose reached after a movement of the robot and are compared with simulated sensor data that the sensor simulation determines in a simulated pose that was reached after simulation of the movement in the robot simulation.

15. The method in accordance with claim 1,
wherein real sensor data are detected by the sensor in a real pose reached after a movement of the robot and are compared with simulated sensor data that the sensor simulation determines in the real pose.

16. A system having a robot, a robot controller, a sensor moved along with the robot, and a processing unit at least indirectly connected to the robot controller and the sensor,
wherein a robot simulation for simulating movements of the robot and a sensor simulation for simulating measurements of the sensor are implemented in the processing unit as well as a method or validating a pose of the robot and/or of sensor data of the sensor in accordance with claim 1.
